(19) United States
(12) Patent Application Publication
(10) Pub. No.: US 2015/0067107 A1
(43) Pub. Date: Mar. 5, 2015

(54) Selectively Providing Local and Remote Services to Wireless Communication Devices

(71) Applicant: EXTENET SYSTEMS, INC., Lisle, IL (US)

(72) Inventors: Tormod Larsen, Lisle, IL (US); Eric Abbott, Lisle, IL (US); Eric Lekacz, Lisle, IL (US); Martin Jensen, Lisle, IL (US); Jason Osborne, Lisle, IL (US); Nimish Adhvaryu, Lisle, IL (US)

(73) Assignee: EXTENET SYSTEMS, INC., Lisle, IL (US)

(21) Appl. No.: 14/014,917

(22) Filed: Aug. 30, 2013

(51) Int. Cl. H04W 28/16

(52) U.S. Cl. CPC H04W 28/16
USPC 709/219

(57) ABSTRACT

An occurrence of a particular event related to a local radio access network may be detected. The local radio access network may be configured to provide wireless service to WCDs. Possibly in response to the occurrence of the particular event, a local content server device or a remote content server device may be selected. At least some transactions involving a particular WCD served by the local radio access network may be routed between the particular WCD and the selected content server device. The local content server device may contain at least some content that is also contained by the remote content server device.

### BACKGROUND

While wide-area wireless networks continue to be deployed, ubiquitous wireless coverage, as well as wireless access to various types of local content, remains problematic. Particularly, first responders, such as police, fire, emergency management, and homeland security officials, may subscribe to different commercial service providers. Some of these first responders may also subscribe or have access to a dedicated, or partially-dedicated, wireless first-responder network. In emergency situations, access to either the commercial or first-responder networks may be impaired.

### SUMMARY

It may prove beneficial for first responders, and/or potentially other types of wireless subscribers, to be able to access both commercial and dedicated wireless networks using the same wireless communication device (WCD). Further, it may also be beneficial for these subscribers to conduct transactions with either local or remote content servers, as the situation warrants.

For example, first responders may be issued a WCD that is configured to use a first-responder wide-area wireless network (“first-responder network”) for communication. The first-responder network may provide dedicated or semi-dedicated service for first responders, and may provide access to content relative to the approximate location of the WCD, such as local maps, building diagrams, communication (e.g., instant messaging, voice, or video) services, and other types of content. The first-responder network may provide access to the Internet as well, and, in turn, access to remote services provided thereon.

The WCD may also be configured to use a commercial wide-area wireless network (“commercial network”) for communication. The commercial network may provide the WCD with access to the Internet and the associated remote services, but may not support the same local services as the first-responder network.

The WCD may use one, the other, or both of these networks based on characteristics of the WCD, location of the WCD, and/or occurrence of a particular event. In other words, WCDs with particular WCD identifiers, or associated with particular individuals, may prefer using one network rather than the other. Alternatively or additionally, WCDs may prefer using one network over the other based on the WCD's location. Alternatively or additionally, WCDs may prefer using one network over the other based on determination that a particular event (e.g., an emergency situation, a network outage, network congestion, etc.) has occurred.

Accordingly, in an example embodiment, a system may include a local routing mechanism and a decision point. The local routing mechanism may be configured to route transactions between WCDs and content server devices, where the WCDs are served by a local radio access network. The decision point may be configured to select a local content server device or a remote content server device with which at least some transactions involving a particular WCD are to be routed. The decision point may also be configured to instruct the local routing mechanism to route the transactions between the particular WCD and the selected content server device. The selected content server device may be selected based on at least one characteristic of the particular WCD or an occurrence of a particular event impacting the system. The local content server device may contain at least some content that is also contained by the remote content server device.

In another example embodiment, an occurrence of a particular event related to a local radio access network may be detected. The local radio access network may be configured to provide wireless service to WCDs. Possibly in response to the occurrence of the particular event, a local content server device or a remote content server device may be selected. At least some transactions involving a particular WCD served by the local radio access network may be routed between the particular WCD and the selected content server device. The local content server device may contain at least some content that is also contained by the remote content server devices.

In yet another example embodiment, an article of manufacture may include a non-transitory computer-readable medium. The computer-readable medium may have, stored thereon, program instructions that, upon execution by a computing device, cause the computing device to perform operations. These operations may include detecting an occurrence of a particular event related to a local radio access network, where the local radio access network is configured to provide wireless service to WCDs. The operations may also include selecting a local content server device or a remote content server device with which at least some transactions involving a particular WCD served by the local radio access network are to be routed, where the local content server device contains at least some content that is also contained by the remote content server device. The operations may further include routing the transactions between the particular WCD and the selected content server device.

In still another example embodiment, a system may be provided. The system may include means for detecting an occurrence of a particular event related to a local radio access network, where the local radio access network is configured to provide wireless service to WCDs. The system may also include means for selecting a local content server device or a remote content server device with which at least some transactions involving a particular WCD served by the local radio access network are to be routed, where the local content server device contains at least some content that is also contained by the remote content server device. The system may further include means for routing the transactions between the particular WCD and the selected content server device.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 depicts a communication network, in accordance with an example embodiment.

FIG. 2 is a block diagram of a computing device, in accordance with an example embodiment.

FIG. 3 depicts a message flow, in accordance with an example embodiment.

FIG. 4 depicts another message flow, in accordance with an example embodiment.

FIG. 5 depicts a flow chart, in accordance with an example embodiment.

### DETAILED DESCRIPTION

### 1. Communication Network Overview

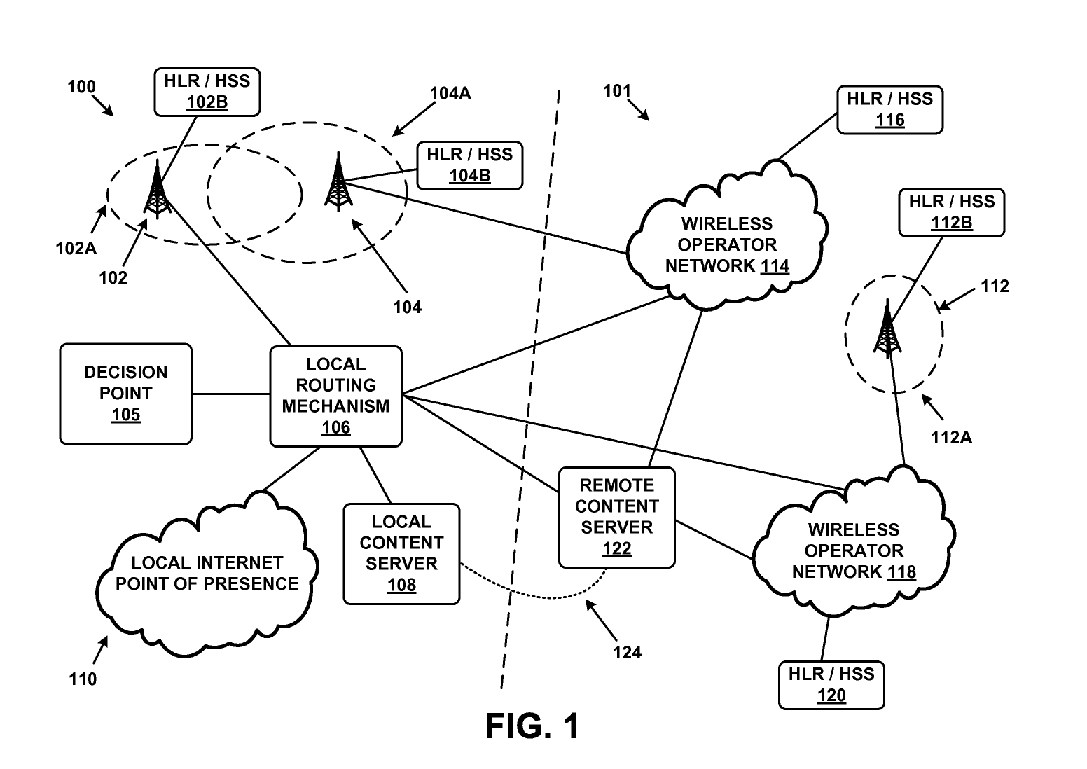

FIG. 1 is an example communication network in which one or more embodiments may be employed. At a high level, FIG. 1 includes local network 100 and remote network 101. However, in full generality, both local network 100 and remote network 101 may be capable of communicating with one or more additional public or private networks using various circuit-switching and/or packet-switching technologies.

Local network 100 may include one or more radio access networks 102, 104. These radio access networks may include radio access network equipment, such as various types of base transceiver stations (BTSs), base station controllers (BSCs), mobile switching centers (MSCs), packet data gateways, and other categories of equipment or nodes. Radio access networks 102, 104 may employ various BTS architectures (e.g., macro-cells, micro-cells, pico-cells, femto-cells, distributed BTSs, or other types of BTS architectures now known or developed in the future). Each BTS may radiate to define one or more wireless coverage areas, such as wireless coverage area 102A defined by a BTS of local radio access network 102, and wireless coverage area 104A defined by a BTS of local radio access network 104. In some embodiments, the extent of wireless coverage area 102A and/or wireless coverage area 104A may be largely limited to or commensurate with a campus, a building, a sports venue, and so on.

Each wireless coverage area may provide air interface access to WCDs (the WCDs are not shown). The air interfaces may include forward links from the BTSs to WCDs and reverse links from WCDs to the BTSs. WCDs may exchange signaling, voice, data, video, or other media through the forward and reverse links. In this regard, WCDs may use the wireless coverage areas to communicate with one or more endpoints, e.g., other WCDs, e-mail servers, world-wide web servers, gaming servers, media servers, media gateways, or location-based services, via a packet-switched network and/or a circuit-switched network.

The air interface(s) of local network 100 may operate according to one or more wireless networking technologies and/or standards. Thus, for instance, forward air interface channels between the BTSs and WCDs may be formed via a set of orthogonal Code Division Multiple Access (CDMA) Walsh codes, each of which may be used to modulate the data that the BTSs transmit on a particular channel. The channels may include a pilot channel, over which a phase offset pattern is repeatedly transmitted, a sync channel over which synchronization data is transmitted (e.g., including a time reference available to the antenna nodes), and traffic channels over which the data directed to WCDs is transmitted. Additionally, one or more of the Walsh codes may be designated as primary and/or secondary paging channels.

The reverse channels may also be formed through the use of CDMA and may include, for example, an access channel for responding to paging messages, and reverse traffic channels. Of course CDMA is not the only technology that can provide wireless forward and reverse link channels, and other technologies may be used instead. These other technologies include, but are not limited to, Worldwide Interoperability for Microwave Access (WIMAX®), Universal Mobile Telecommunications System (UMTS®), the Global System for Mobile Communications (GSM), Long Term Evolution (LTE®), IDEN®, and Wifi.

While each radio access network defines one wireless coverage area in FIG. 1, a radio access network may be configured to define more wireless coverage areas. Further, FIG. 1 also depicts wireless coverage areas 102A and 104A overlapping to some extent. In alternate embodiments, these wireless coverage areas may overlap to any degree or not overlap at all. Moreover, each of the wireless coverage areas may be defined using different carrier frequencies. Alternatively, at least some of the wireless coverage areas may be defined with the same carrier frequency, and therefore may be able to provide WCDs with a substantially continuous wireless coverage as these WCDs are handed off from radio access network to radio access network. In some embodiments, local radio access network 102 may be a first-responder network, while local radio access network 104 may be a commercial network.

Local radio access network 102 may include or have access to Home Location Register/Home Subscriber Server (HLR/HSS) 102B, and local radio access network 104 may include or have access to HLR/HSS 104B. HLR/HSS 102B and 104B may contain subscriber records for WCDs subscribed to local radio access network 102 and local radio access network 104, respectively. Thus, HLR/HSS 102B and 104B may store or have access to identifying information of these WCDs. This identifying information may include, but is not limited to, network access identifiers (NAIs), mobile directory numbers (MDNs), mobile identification numbers (MINs), international mobile subscriber identifiers (IMSIs), electronic serial numbers (ESNs), international mobile equipment identifiers (IMEIs), and mobile equipment identifiers (MEIDs). Any of these types of WCD identifiers, or other data, may be used to identify WCDs subscribed to local radio access network 102 and local radio access network 104. In some embodiments, HLR/HSS 104B may not be present, and local radio access network 104 may use HLR/HSS 116 instead.

As shown in FIG. 1, local radio access network 102 may be communicatively coupled to local routing mechanism 106, as well as local content server 108, remote content server 122, and Internet point of presence 110. On the other hand, local radio access network 104 may be communicatively coupled to wireless operator network 114, which may provide Internet access, and access to remote content server 122, for WCDs served by local radio access network 104.

Local routing mechanism 106 may be a switch, router, gateway, or some other type of device that determines, possibly on a WCD-by-WCD basis, whether to route a WCD's communications locally or remotely. Thus, for instance, local routing mechanism 106 may route a WCD's communications to wireless operator network 114, wireless operator network 118, local content server 108, and/or remote content server 122. In some scenarios, remote content server 122 may be reachable via Internet point of presence 110.

The decision of where to route these communications may be based on a particular WCD identifier of the WCD, a particular individual associated with the WCD, the WCD's location, a determination that a particular event (e.g., an emergency situation, a network outage, network congestion, etc.) has occurred and/or some other information or event. In some embodiments, these decisions may be made by decision point 105, which may be a physical device that is distinct from local routing mechanism 106. Alternatively, decision point 105 may be combined with local routing mechanism 106, or some other part of local network 100, in the same physical device.

Local content server 108 may be a server device, or a set of server devices, that contains or has access to various types of content (e.g., web pages, media files, and/or media streams). This content may be of local significance to WCDs served by local radio access network 102, and may include local maps, local building diagrams, local weather conditions, etc. Alternatively or additionally, this content may be premium content that is only available to certain WCDs using local network 100. Alternatively or additionally, local content server 108 may contain a cache of at least some content from other sources (e.g., a web cache or media cache), such as remote content server 122. Via optional link 124, remote content server 122 may share its content with local content server 108.

Remote content server 122 may also be a server device, or set of server devices, that stores and/or provides content. This content may be any type of information and/or media, and may include information and/or media of local significance to particular geographical areas.

Remote network 101 may include wireless operator network 114, which may contain or have access to HLR/HSS 116. Remote network 101 may also include remote radio access network 112, radiating to define wireless coverage area 112A, and configured to provide WCDs with access to wireless operator network 118, as well as remote content server 122. Remote radio access network 112 may contain or have access to HLR/HSS 112B, or may use HLR/HSS 120 instead. HLR/HSS 120 may also be contained in or available to wireless operator network 118. In some embodiments, a remote routing mechanism (not shown) may exist. The remote routing mechanism may be or include a router, switch, gateway, or some other device configured to route transactions between WCDs served by remote radio access networks and remote content server 122.

Each of wireless operator network 114 and wireless operator network 118 may be operated by a different wireless service provider. For instance, both wireless operator networks may be operated by nationwide cellular service providers, or wireless operator network 114 may be operated by a nationwide cellular service provider while wireless operator network 118 may be operated by a regional cellular service provider.

Aside from HLR/HSS 116, and 120, respectively, each of wireless operator network 114 and wireless operator network 118 may contain other devices. These other devices may include but are not limited to BTSs, BSCs, MSCs, tandem switches, signaling proxies, media gateways, routers, firewalls, content servers, and other types of equipment that facilitate voice and/or data communication.

HLR/HSS 112B, 116, and 120 may contain subscriber records for WCDs subscribed to remote radio access network 112, wireless operator network 114, and wireless operator network 118, respectively. Thus, HLR/HSS 112B, 116, and 120 may store or have access to identifying information of these WCDs. This identifying information may include, but is not limited to, NAIs, MDNs, MINs, IMSIs, ESNs, IMEIs, and MEIDs.

Various devices in wireless operator network 114 may query HLR/HSS 116 in order to authenticate a WCD attempting to gain access to wireless operator network 114. Additionally, various devices in wireless operator network 114 may query HLR/HSS 116 in order to determine whether a WCD is authorized to use a particular service. Similarly, various devices in wireless operator network 118 may query HLR/HSS 120 in order to authenticate a WCD attempting to gain access to wireless operator network 118. Moreover, various devices in wireless operator network 118 may query HLR/HSS 120 in order to determine whether a WCD is authorized to use a particular service.

In addition to devices in wireless operator network 114 and wireless operator network 118 querying HLR/HSS 116 and 120, respectively, devices in other networks may also query HLR/HSS 116 and/or 120 to authenticate or determine the authorization of WCDs. In full generality, the system of FIG. 1 may include many more local radio access networks, each of which may provide access to remote content server 112. These local radio access networks may be operated by one or more wireless service providers, and may be commercial wireless networks, first-responder wireless networks, or some other type of network.

### 2. Device Hardware and Software Architecture

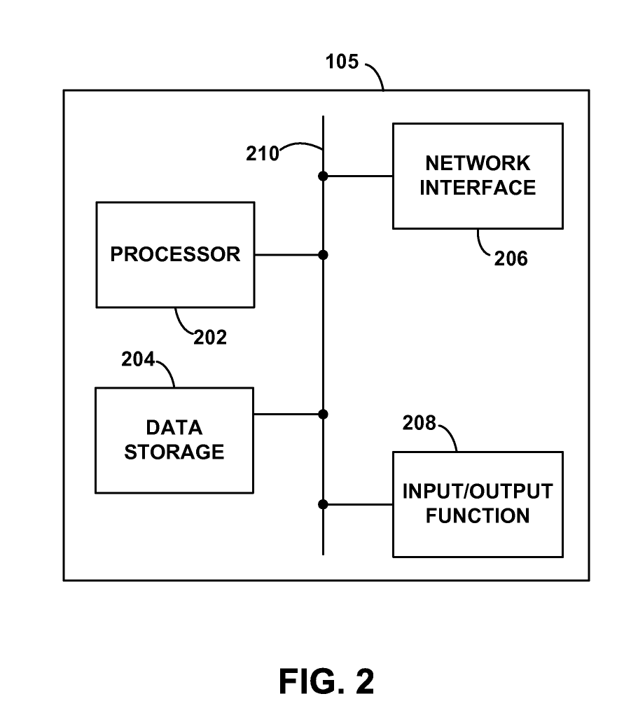

FIG. 2 is a simplified block diagram exemplifying decision point 105, and illustrating one or more of the functional elements that may be found in a device arranged to operate in accordance with the embodiments herein. Decision point 105 could be any type of device capable of networked communication. Thus, decision point 105 could be a desktop computing device, a server device, or a cluster of server devices. For purposes of illustration, decision point 105 may be described as a server device. Nonetheless, it should be understood that the description of decision point 105 and its components may apply to other types of devices.

Decision point 105 may include a processor 202, a data storage 204, a network interface 206, and an input/output function 208, all of which may be coupled by a system bus 210 or a similar mechanism. Processor 202 may include one or more CPUs, such as one or more general purpose processors and/or one or more dedicated processors (e.g., application specific integrated circuits (ASICs) or digital signal processors (DSPs), etc.).

Data storage 204, in turn, may comprise volatile and/or non-volatile data storage and can be integrated in whole or in part with processor 202. Data storage 204 may store program instructions, executable by processor 202, and data that is manipulated by these instructions to carry out the various methods, processes, or functions described herein. Alternatively, these methods, processes, or functions can be defined by hardware, firmware, and/or any combination of hardware, firmware, and software. Therefore, data storage 204 may be a non-transitory computer-readable medium, having stored thereon program instructions that, upon execution by decision point 105, cause decision point 105 to carry out any of the methods, processes, or functions disclosed in this specification or the accompanying drawings.

Network interface 206 may be an interface for a wireline connection, such as an Ethernet, Token Ring, or T-carrier connection. Alternatively or additionally, network interface 206 may be an interface for a wireless connection, such as IEEE 802.11 (Wifi), BLUETOOTH®, or a wide-area wireless connection. However, network interface 206 may support other forms of physical layer connections and other types of standard or proprietary communication protocols. Furthermore, network interface 206 may comprise multiple physical communication interfaces.

Input/output function 208 may facilitate user interaction with decision point 105. Input/output function 208 may comprise one or more of any type of input device, such as a keypad, a keyboard, a mouse, a scroll wheel, a microphone, a joystick, a touch screen, a switch, a button, etc. Similarly, input/output function 208 may comprise one or more of any type of output device, such as a video screen, a monitor, a printer, a speaker, a light emitting diode (LED), etc. Additionally or alternatively, decision point 105 may support remote access from another device, via network interface 206 or via another interface (not shown), such an RS-232 or Universal Serial Bus (USB) port.

As noted above, decision point 105 may be combined in the same physical device with any other component of local network 100, such as local radio access network 102, local radio access network 104, local routing mechanism 106, local content server 108, or some other component.

### 3. Example Scenarios

The system and device architectures of FIGS. 1 and 2, respectively, may be used to enable a variety of scenarios. Some of these are discussed below. However, these system and device architectures may be used to enable additional scenarios not explicitly described herein as well.

In some scenarios, local radio access network 102 may be a first responder network, or part of a larger first-responder network. For instance, wireless spectrum in a particular range or ranges may be reserved nationwide for communication involving police, fire, emergency management, and/or homeland security officials. This spectrum may be employed by one or more first-responder networks that may be interconnected or associated with one another in some fashion. Thus, a first-responder WCD (e.g., a WCD that is subscribed to the first-responder network), that is powered on or comes within range of the first-responder network, may use this network for communication.

In order to facilitate use of the first responder network, a device identifier of each first-responder WCD may be populated in a database of such devices. The database may be accessible to the first-responder network. This database may take to the form of, or be integrated with, an HLR/HSS. Via this database, the first-responder network may authenticate WCDs attempting to access the first-responder network. Thus, first-responder WCDs may be permitted to use the first-responder network, while other WCDs may be denied access.

Additionally, first-responder WCDs may also be subscribed to one or more commercial wide-area wireless service providers. Thus, a first-responder WCD may be a device specialized for first-responder use, or an off-the-shelf device (e.g., a standard cell phone) that has been granted access to the first-responder network. In this way, first responders may be able to use their own devices for both personal and first-responder activities.

As an example, consider a fire chief who has a personal cell phone subscribed to a commercial wireless service provider. When using this phone for personal use, e.g., around the house or on personal business, the phone may use the services of the commercial wireless service provider. However, when on the job or at an emergency site, the phone may use the service of the first-responder network. In some situations, the phone may be configured to use both networks simultaneously.

The phone may determine which network to use based on input from the user (e.g., the fire chief may manually switch the phone between the commercial wireless network and the first-responder network), location (e.g., while in the vicinity of a fire station, the phone may automatically switch to using the first-responder network), and/or event (e.g., in response to receiving a signal indicating that an emergency situation is underway, the phone automatically switches to the first-responder network). In embodiments in which the phone automatically switches to the first-responder network, the phone may also switch from the first-responder network to the commercial wireless network once the phone location has changed again (e.g., the phone is no longer in the vicinity of the fire station) or when it receives a signal indicating that the emergency situation is over.

In this way, a first-responder network, with dedicated capacity for first-responder communication, may be deployed and used. First responders may utilize the capacity of this network in emergency situations, when commercial networks could be congested. For instance, soon after there is an earthquake in a particular city, the commercial wireless networks in the area may be overwhelmed with individuals trying to make calls. However, the first responder network is unlikely to be loaded to such an extent, because the limited number of individuals and devices permitted to use it.

In some situations, such as when there is no emergency situation underway in a particular location, some commercial WCDs may be allowed to use the spare capacity of the first-responder network. In this way, commercial wireless service providers may charge their subscribers a fee for the “premium” service of using the first-responder network when it is available. Alternatively or additionally, the first-responder network may also be available to commercial WCDs at all times, but first-responder WCDs may be given a higher priority in general or during emergencies.

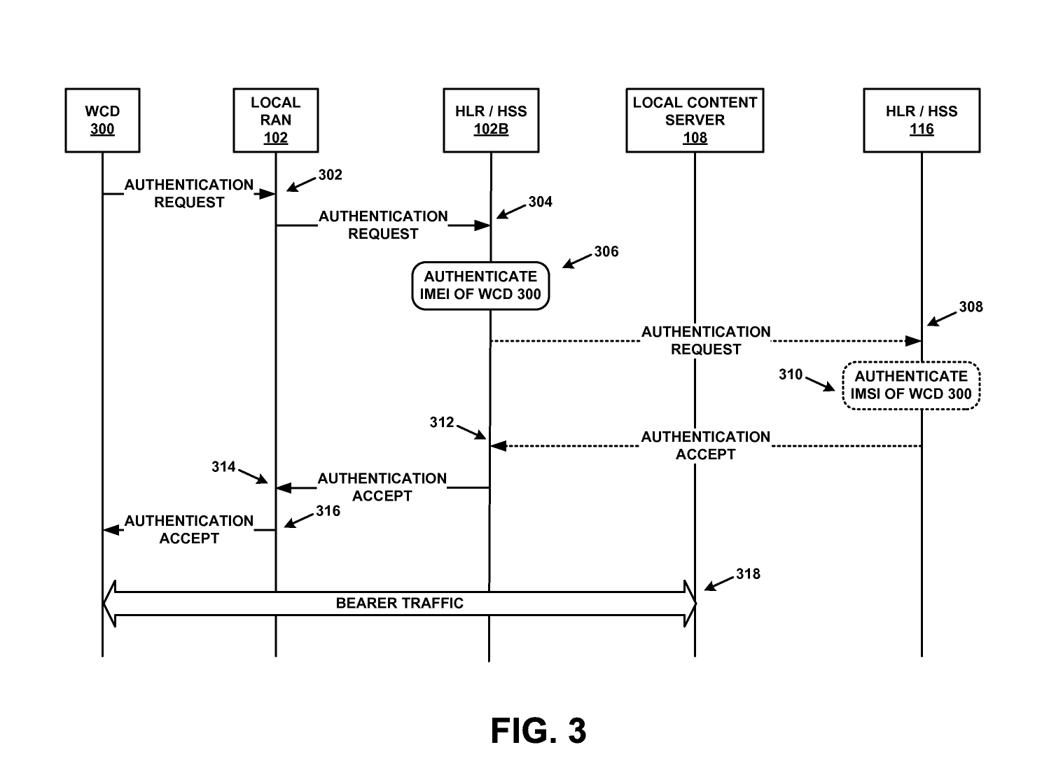

FIG. 3 is a message flow depicting a possible embodiment for authenticating a WCD to use a first-responder network. In FIG. 3, WCD 300 may be subscribed to local radio access network (RAN) 102, or possibly to wireless operator network 114. In this embodiment, it is assumed that local radio access network 102 is a first-responder network. WCD 300 may be attempting to access content stored at local content server 108. In order to do so, WCD 300 may first authenticate itself to local radio access network 102, and possibly wireless operator network 114.

Thus, at step 302, WCD 300 may transmit an authentication request to local radio access network 102. This authentication request may take various forms that may be specific to a type of wireless technology that WCD 300 is using to communicate with local radio access network 102 (e.g., CDMA, WIMAX®, UMTS®, LTE®, IDEN®, or Wifi). Particularly, the authentication request may include a WCD identifier of WCD 300, such as an NAI, MDN, MIN, IMSI, ESN, IMEI, and/or MEID. The authentication request may also include some form of password or authentication token that can be used to validate that the authentication request was generated by WCD 300.

At step 304, local radio access network 102 may transmit the authentication request to HLR/HSS 102B. At step 306, perhaps in response to receiving the authentication request, HLR/HSS 102B may locally authenticate WCD 300. This authentication may take various forms. In some embodiments, HLR/HSS 102B may contain or have access to a local database of WCD identifiers of WCDs that are primarily or only subscribed to the first-responder network.

To locally authenticate WCD 300, HLR/HSS 102B may look up the WCD identifier of WCD 300 in the local database. In some cases, this WCD identifier may be a hardware or device identifier, such as an IMEI. If the WCD identifier is found in the local database, WCD 300 may be considered to be locally authenticated. Then, at step 314, HLR/HSS 102B may transmit an authentication accept to local radio access network 102. At step 316, local radio access network 102, may transmit the authentication accept to WCD 300, confirming that WCD 300 is authenticated to use the first-responder network. As a result, at step 318, WCD 300 may begin exchanging bearer traffic with local content server 108.

If WCD 300 is not a first-responder WCD, then additional steps may be involved in order to authenticate WCD 300. For instance, HLR/HSS 102B may determine, based on the WCD identifier of WCD 300, that WCD 300 is a subscriber to wireless operator network 114. Consequently, at step 308, HLR/HSS 102B may transmit the authentication request to HLR/HSS 116.

At step 310, perhaps in response to receiving the authentication request, HLR/HSS 116 may locally authenticate WCD 300. Like HLR/HSS 102B, HLR/HSS 116 may contain or have access to a local database of WCD identifiers of WCDs that are primarily or only subscribed to wireless operator network 114. To locally authenticate WCD 300, HLR/HSS 116 may look up the WCD identifier of WCD 300 in the local database. In some cases, this WCD identifier may be a soft identifier, such as an NAI, MDN, or IMSI. If the WCD identifier is found in the local database, WCD 300 may be considered to be locally authenticated. Then, at step 312, HLR/HSS 116 may transmit an authentication accept to HLR/HSS 102B. These three steps, 308, 310, and 312, are diagramed using dotted lines in FIG. 3 to indicate that they may not occur during every WCD authentication.

Once a WCD is authenticated to use a first-responder network, various events might determine, at least in part, whether the WCD's requests for content are routed to a local content server or a remote content server. As noted above, a local content server may store copies of all or a subset of the content stored in a remote content server. Further, a local content server may store information of local relevance that may not be stored at a remote content server.

Thus, the first-responder network may route requests for content that is only stored at a remote content server to the remote content server. The first-responder network may also route requests for content that is only stored at a local content server to the local content server. The first-responder network may make these routing decisions based on an indicator of the requested content, or some other mechanism. In some situations, however, the requested content may be stored at both the local content server and the remote content server, and the first-responder network may route communications between the local radio access network and either of these servers.

In general, the first-responder network may include a decision point that instructs elements of the first-responder network to route network traffic accordingly. For example, in the context of FIG. 1, decision point 105 may detect the occurrence of an event. Based on this occurrence, decision point 105 may instruct local routing mechanism 106 to route communication between a WCD served by local radio access network 102 to local content server 108, remote content server 122, or some other destination.

The term “event” may be interpreted broadly. For instance, an event may include a particular WCD being authenticated to use local radio access network 102, a particular WCD requesting a particular content or type of content, or a particular WCD being in a particular location. Other events may include detection of an emergency condition (e.g., a fire, flood, tornado, hurricane, civil unrest, automobile accident, medical emergency, etc.) in a location proximate to local radio access network 102. Further events include detection of network congestion, or some form of partial or complete impairment of local access network 102, or any network component between, or within, local access network 102 and remote content server 122. In some embodiments, an event may include the current time of day and/or day of week being a particular value(s), and/or the WCD performing particular actions.

In response to making such a determination, decision point 105 may begin routing communication involving one or more WCDs to local content server 108 rather than remote content server 122. In this way, such a WCD may continue communicating with local content server 108 until some further condition is met, such as the WCD's session(s) with local content server 108 is complete, the WCD stops using local radio access network 102 for network access, or until the emergency situation or network condition is over. In some cases, when such a condition is met, the WCD's communication may once again be routed to remote content server 122.

Decision point 105 may detect an event in various ways. For instance, decision point 105 may be informed of when WCDs are authenticated to use local radio access network. In one possible embodiment, HLR/HSS 102B may transmit a message to decision point 105 indicating that a particular WCD has been authenticated. Alternatively, decision point 105 may be incorporated into or co-located with HLR/HSS 102B. In some scenarios, decision point 105 may detect network congestion or impairments by probing, or having access to the results of probes of the network between local radio access network 102 and remote content server 122. Based on this information, decision point 105 may change how traffic from one or more WCDs is routed. As another alternative, any of these events could be manually indicated to decision point 105. For instance, in an emergency, a first responder may change a setting on decision point 105 to specify that the emergency is occurring, and decision point 105 may respond accordingly.

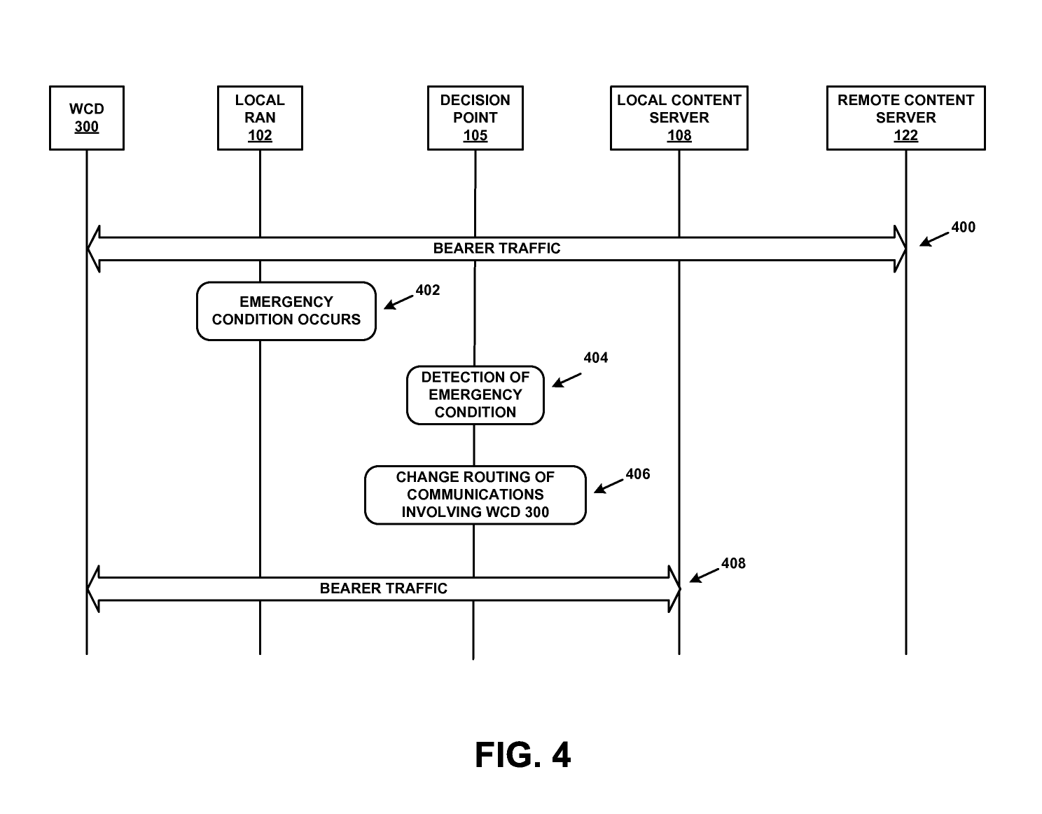

FIG. 4 illustrates an example embodiment. At step 400, WCD 300 may be exchanging bearer traffic with remote content server 122 via local radio access network 102. In some cases, instead of being served by local radio access 102 (a first-responder network), WCD 300 may be served by a commercial wireless network.

At step 402, an emergency condition may occur proximate to local radio access network 102. At step 404, decision point 105 may detect that this emergency condition has occurred. At step 406, possibly in response to the detection of this event and/or that WCD 300 is served by local radio access network 102, decision point 105 may change the routing of communications involving WCD 300. Thus, at step 408, WCD 300 may begin exchanging bearer traffic with local content server 108 via local radio access network 102.

Alternatively, if WCD 300 is served by the commercial wireless network, decision point 105 may change the routing of communications involving WCD 300 to use local content server 108, and WCD 300 may also begin using local radio access network 102 for communication.

To further illustrate this example, consider WCD 300 the WCD of a first-responder. In non-emergency situations, the WCD 300 might access content (e.g., maps, weather conditions, news, etc.) on behalf of the first-responder via remote content server 122. However, when an emergency occurs in the proximate location of the first responder, WCD 300 may begin communicating with local content server 108 instead.

Notably, there may be more processing capacity at local content server 108 to serve requests faster than remote content server 122. Additionally, there may be more network capacity between local radio access network 102 and local content server 108 than between local radio access network 102 and remote content server 122. Thus, the first responder would be able to communicate more efficiently by obtaining content from local content server 122.

Further, local content server 108 may store content of local significance that is not stored by remote content server 122. This might include detailed local maps, building plans, diagrams, schematics, diagrams, and/or layouts, information on the local power grid or water system, secure governmental information, and so on. Moreover, if the emergency involves a destructive force, such as a hurricane or tornado, this force may disable communication lines to remote content server 122. Therefore, local content server 108 may remain available to WCD 300 while remote content server 122 is not.

In some embodiments, communications during an emergency situation, or those using a first-responder network in general, may be prioritized and/or differentiated based on the WCD or WCDs involved. Thus, for example, communication involving a fire chief or police chief may be prioritized over that of a rank-and-file firefighter or police officer.

This traffic prioritization/differentiation may involve assigning WCDs and/or their communication a priority level from two or more predefined priority levels. Alternatively or additionally, the WCDs may be granted a certain bit rate, delay bound, jitter bound, packet dropping rate, and/or bit error rate. Thus, for instance, if local radio access network 102 is congested, local radio access network 102 may process authentication requests (or other signaling or bearer traffic) from higher-priority WCDs with precedence over similar types of traffic from lower-priority WCDs. For data communications involving these WCDs, local radio access network 102 (and perhaps over devices as well) may process and/or forward packets to and from higher-priority WCDs with precedence over packets from lower-priority WCDs. Alternatively or additionally, WCDs may be allowed or denied access to local radio access network 102 based on their respective priorities.

An example system arranged in accordance with the embodiments herein may include a local routing mechanism and a decision point. The local routing mechanism may be configured to route transactions between WCDs and content server devices. The WCDs may be served by a local radio access network.

The decision point may be configured to select a local content server device or a remote content server device with which at least some transactions involving a particular WCD are to be routed. The decision point may also be configured to instruct the local routing mechanism to route the transactions between the particular WCD and the selected content server device. The selected content server device may be selected based on at least one characteristic of the particular WCD, or an occurrence of a particular event impacting the system. The local content server device may contain, or store, at least some content that is also contained by, or stored at, the remote content server device.

The system may further include a plurality of local content server devices comprising the local content server device. The system may also include a plurality of remote content server devices comprising the remote content server device, and a remote routing mechanism. The remote routing mechanism may be configured to route transactions between WCDs served by a plurality of radio access networks and the plurality of remote content server devices. The local radio access network may be one of the plurality of radio access networks.

In some embodiments, the local routing mechanism, the local content server device, and the decision point may be comprised within the local radio access network. In other embodiments, the local radio access network, the local routing mechanism, the local content server device, and the decision point are physically distinct network devices. Alternatively or additionally, the decision point, or some functions thereof, may be comprised within the particular WCD.

The system may additionally include a database of WCD identifiers, each uniquely identifying different WCDs. The particular WCD may be associated with a particular WCD identifier in the database, and the particular event may include the particular WCD accessing the local radio access network. In some embodiments, each WCD identifier may be associated with a priority level, and the WCD identifiers in the database may be associated with a higher priority level than WCD identifiers not in the database. The WCD identifiers may be IMEIs, or any other type of WCD identifier, including but not limited to NAIs, MDNs, MINs, IMSIs, ESNs and MEIDs.

The decision point may be further configured to determine whether connectivity between the local radio access network and the remote content server device is at least partially impaired. The particular event may include the decision point determining that the connectivity is at least partially impaired.

Alternatively or additionally, the decision point may be further configured to determine whether there is an emergency condition in a location proximate to that of the system. The particular event may include the decision point determining that the emergency condition exists.

Alternatively or additionally, the decision point may be further configured to determine whether the particular WCD is requesting particular content for which it is more efficient for the local content server device than the remote content server device to provide. The particular event may include determining that the particular WCD is requesting the particular content.

Alternatively or additionally, the decision point may be further configured to determine whether the particular WCD is requesting particular content that the local content server device provides and the remote content server device does not provide. The event may include determining that the particular WCD is requesting the particular content.

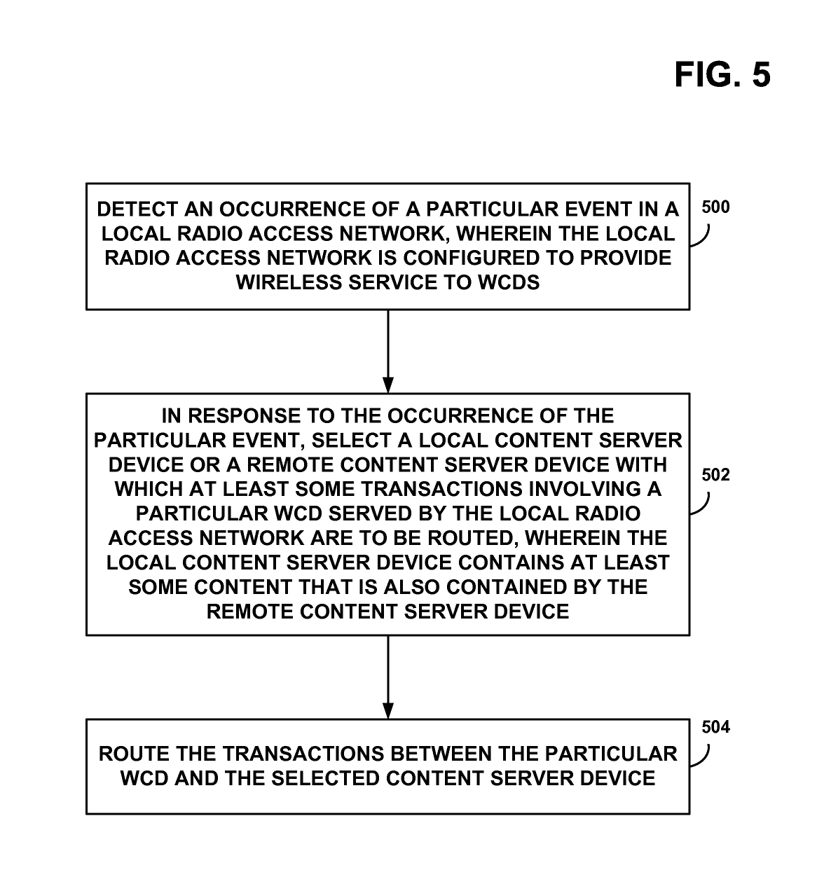

FIG. 5 is a flow chart that depicts an example embodiment. Generally speaking, the steps of these embodiments may be performed by one or more components of local network 100. In some cases, a single component (e.g., decision point 105) may perform all of the steps, while in other cases, different components may perform different steps. Additionally, any other steps or embodiments described herein may be performed as part of this embodiment.

At step 500 of FIG. 5, an occurrence of a particular event related to a local radio access network may be detected. The local radio access network may be configured to provide wireless service to WCDs. The event may occur within the local radio access network or proximate to the location of the local radio access network.

The particular event may include the particular WCD accessing the local radio access network, where the particular WCD is associated with a particular WCD identifier stored in a database. Further, WCD identifiers may be associated with respective priority levels, and the WCD identifiers stored in the database may be associated with a higher priority level than WCD identifiers not stored in the database.

Alternatively or additionally, the particular event may include determination that communication between the local radio access network and the remote content server device is at least partially impaired. Alternatively or additionally, the particular event may include determination that there is an emergency condition in a location proximate to that of the system. Alternatively or additionally, the particular event may include determination that the particular WCD is requesting particular content for which it is more efficient for the local content server device than the remote content server device to provide.

At step 502, possibly in response to the occurrence of the particular event, a local content server device or a remote content server device may be selected. At least some transactions involving a particular WCD served by the local radio access network may be routed via the selected content server device. The local content server device may contain at least some content that is also contained by the remote content server device. At step 504, the transactions may be routed between the particular WCD and the selected content server device.

### 4. Conclusion

The above detailed description describes various features and functions of the disclosed systems, devices, and methods with reference to the accompanying figures. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
a local routing mechanism configured to route transactions between wireless communication devices (WCDs) and content server devices, wherein the WCDs are served by a local radio access network; and
a decision point configured to select a local content server device or a remote content server device with which at least some transactions involving a particular WCD are to be routed, and to instruct the local routing mechanism to route the transactions between the particular WCD and the selected content server device, wherein the selected content server device is selected based on at least one characteristic of the particular WCD or an occurrence of a particular event impacting the system, and wherein the local content server device contains at least some content that is also contained by the remote content server device.

2. The system of claim 1, further comprising:
a plurality of local content server devices comprising the local content server device.

3. The system of claim 2, further comprising:
a plurality of remote content server devices comprising the remote content server device; and
a remote routing mechanism configured to route transactions between WCDs served by a plurality of radio access networks and the plurality of remote content server devices, wherein the local radio access network is one of the plurality of radio access networks.

4. The system of claim 1, wherein the local routing mechanism, the local content server device, and the decision point are comprised within the local radio access network.

5. The system of claim 1, wherein the local radio access network, the local routing mechanism, the local content server device, and the decision point are physically distinct network devices.

6. The system of claim 1, wherein the decision point is comprised within the particular WCD.

7. The system of claim 1 further comprising:
a database of WCD identifiers, each uniquely identifying different WCDs, wherein the particular WCD is associated with a particular WCD identifier in the database, and the particular event includes the particular WCD accessing the local radio access network.

8. The system of claim 7, wherein each WCD identifier is associated with a priority level, and wherein the WCD identifiers in the database are associated with a higher priority level than WCD identifiers not in the database.

9. The system of claim 7, wherein the WCD identifiers are International Mobile Equipment Identifiers.

10. The system of claim 1, wherein the decision point is further configured to determine whether connectivity between the local radio access network and the remote content server device is at least partially impaired, and wherein the particular event includes the decision point determining that the connectivity is at least partially impaired.

11. The system of claim 1, wherein the decision point is further configured to determine whether there is an emergency condition in a location proximate to that of the system, and wherein the particular event includes the decision point determining that the emergency condition exists.

12. The system of claim 1, wherein the decision point is further configured to determine whether the particular WCD is requesting particular content for which it is more efficient for the local content server device than the remote content server device to provide, and wherein the particular event includes determining that the particular WCD is requesting the particular content.

13. The system of claim 1, wherein the decision point is further configured to determine whether the particular WCD is requesting particular content that the local content server device provides and the remote content server device does not provide, and wherein the event includes determining that the particular WCD is requesting the particular content.

14. A method comprising:
detecting an occurrence of a particular event related to a local radio access network, wherein the local radio access network is configured to provide wireless service to wireless communication devices (WCDs);
in response to the occurrence of the particular event, selecting a local content server device or a remote content server device with which at least some transactions involving a particular WCD served by the local radio access network are to be routed, wherein the local content server device contains at least some content that is also contained by the remote content server device; and
routing the transactions between the particular WCD and the selected content server device.

15. The method of claim 14, wherein the particular event includes the particular WCD accessing the local radio access network, wherein the particular WCD is associated with a particular WCD identifier stored in a database.

16. The method of claim 15, wherein WCD identifiers are associated with respective priority levels, and wherein the WCD identifiers stored in the database are associated with a higher priority level than WCD identifiers not stored in the database.

17. The method of claim 14, wherein the particular event includes determination that communication between the local radio access network and the remote content server device is at least partially impaired.

18. The method of claim 14, wherein the particular event includes determination that there is an emergency condition in a location proximate to that of the system.

19. The method of claim 14, wherein the particular event includes determination that the particular WCD is requesting particular content for which it is more efficient for the local content server device than the remote content server device to provide.

20. An article of manufacture including a non-transitory computer-readable medium, having stored thereon program instructions that, upon execution by a computing device, cause the computing device to perform operations comprising:
detecting an occurrence of a particular event related to a local radio access network, wherein the local radio access network is configured to provide wireless service to wireless communication devices (WCDs);
in response to the occurrence of the particular event, selecting a local content server device or a remote content server device with which at least some transactions involving a particular WCD served by the local radio access network are to be routed, wherein the local content server device contains at least some content that is also contained by the remote content server device; and
routing the transactions between the particular WCD and the selected content server device.
